(19) United States
(12) Patent Application Publication
(10) Pub. No.: US 2003/0197148 A1
(43) Pub. Date: Oct. 23, 2003

(54) Globe valve

(76) Inventors: Heinz Luke, Schloss Holte (DE); Roland Unruh, Hameln (DE)

Correspondence Address: Samuels, Gauthier & Stevens LLP, Suite 3300, 225 Franklin Street, Boston, MA, 02110, US

(21) Appl. No.: 10/365,881

(22) Filed: Feb. 13, 2003

Related U.S. Application Data
(63) Continuation of application No. PCT/EP02/07254, filed on Jul. 2, 2002.

(30) Foreign Application Priority Data
Jul. 14, 2001 (DE) 20111721.5

(51) Int. Cl. F16K 3/00

(52) U.S. Cl. 251/326

(57) ABSTRACT

A globe valve, with a valve chamber 1 which has a flow line that may be shut off by a plug actuatable by an axially adjustable valve spindle, wherein the plug in the shutoff position rests forming a seal against a valve seat oriented obliquely to the direction of flow, characterized in that the nominal width and face-to-face dimension of the valve chamber match the dimensions defined by the standards for valves and fittings of the sandwich design.

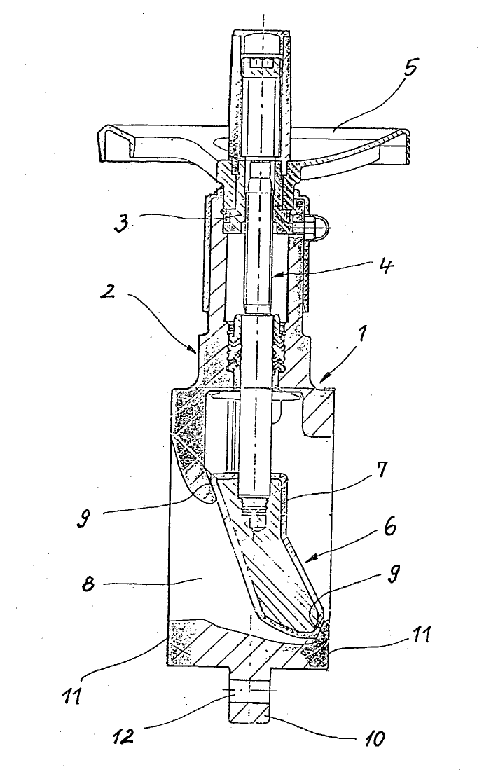

### BACKGROUND OF THE INVENTION

1. Field of Invention

The present invention relates to a globe valve with a valve chamber 1 which has a flow line that may be shut off by a plug actuatable by an axially adjustable valve spindle, wherein the plug in the shutoff position rests forming a seal against a valve seat oriented obliquely to the direction of flow.

2. Description of Prior Art

Globe valves of this type find application in many areas. They have considerable advantages over, for example, butterfly valves, specifically in terms of leak-tightness, controllability, and service life.

In response to frequent use, for example after multiple shutoffs of butterfly valves, the sealing surface between the plug and the valve seat is subject to wear, which results in deterioration of its functionality, and which, depending on design, may be remedied only by replacing the sealing elements.

In contrast, any wear phenomena in a globe valve that might impair the leak-tightness of the valve seat or plug are to a considerable degree compensated by the fact that increased pressure is applied to the plug by the valve spindle—with the result that better contact pressure on the valve seat is achieved.

Controllability of the globe valve is better than for the butterfly valve, specifically due to the shape of the plug. This is due principally to the fact that the flap disk of the butterfly valve pivots about a vertical axis, thereby providing a large flow cross section in response to a small amount of pivoting. As a result, pressure shocks (water hammer) may also be generated in the piping system.

Nevertheless, butterfly valves are characterized by very small face-to-face dimensions, as are slide valves or similar valves and fittings—feature which is desirable for many areas of application.

### SUMMARY OF THE INVENTION

The goal of the invention is to design a globe valve according to the species in such a way as to improve its usability.

The goal is achieved by a globe valve which has the characteristic features of claim 1.

This design of a globe valve enables these to be employed even in areas where previously it was only possible to use butterfly valves, slide valves, or ball valves. This, of course, enables globe valves to have a considerably larger range of application than formerly.

In addition, already installed butterfly valves may be readily replaced by a globe valve of the design according to the invention.

Specifically, the small face-to-face dimension relative to the nominal diameter allows for optimum utilization of the globe valve.

Here the configuration of the valve seat and of the plug contacting it in the shutoff position is critical. Of particular importance here is the oblique orientation of the valve seat, namely, of the seating face which the plug contacts circumferentially, the plug generally being covered by an elastic sealing means.

In an advantageous modification of the invention, the seating face of the valve seat is circumferentially inclined so that the intersection points of the respective diametrically opposing generating lines by which the valve seat is defined encompass one surface.

As has been surprisingly demonstrated, this design is especially well suited to implement the characteristic features of claim 1 by optimizing leak-tightness on the one hand and flow resistance on the other.

In addition, a globe valve of this design is especially inexpensive to fabricate and thus has no disadvantages relative to inexpensive butterfly valves—with the result that this new globe valve may readily be viewed as an equivalent replacement for a butterfly valve in a wide range of applications.

Additionally, provision may be made to tilt the spindle eccentrically depending on the oblique orientation of the valve seat—a feature which also contributes to optimization of the new valve.

Additional embodiments of the invention are identified in the subclaims.

### BRIEF DESCRIPTION OF THE DRAWINGS

One embodiment of the invention is described below based on the attached drawing.

The single FIGURE provides a cross-sectional view of a globe valve according to the invention.

### DETAILED DESCRIPTION OF THE DRAWINGS

The FIGURE shows a globe valve which has a valve chamber 1 to which a chamber neck 2 is connected in which a spindle nut 3 is mounted rotatably but axially secured.

A hand wheel 5 is affixed by spindle nut 3, by which wheel the spindle nut is movable.

An axially adjustable valve spindle 4 passes through spindle nut 3, the outer thread of the valve spindle meshing with the inner thread of spindle nut 3, as a result of which the axial motion of valve spindle 4 is effected when hand wheel 5 is turned.

Valve chamber 1 has two opposing end surfaces 11 running parallel to each other which may be mounted between two pipeline ends, not shown, end surfaces 11 then contacting flanges of the pipeline ends. The flanges of the pipeline ends are connected by screws. These screws pass through holes 12 which are provided in the chamber-side flange 10 of valve chamber 1. This flange 10 is approximately centered relative to the face-to-face dimension of valve chamber 1.

The globe valve is centered and mounted between the tube ends by screws which, as mentioned, pass through holes 12.

In place of holes 12, which are through-holes, threaded holes may be provided into which the screws may be inserted which may pass through the through-holes of the pipeline flanges, and by which the globe valve is securely connected to the pipelines.

In addition, valve chamber 1 has a flow line 8 through which a medium flowing through said pipes may pass.

An obliquely oriented valve seat 9 is provided in valve chamber 1 to shut off the flow, the valve seat having a surrounding face on which plug 6 may rest to form a seal, plug 6 being covered with an elastic sealing means 7.

Valve spindle 4 is connected in rotationally locked fashion to plug 6 such that when hand wheel 5, and thus spindle nut 3, is turned, valve spindle 4 moves axially, as does plug 6 in the same direction.

According to the invention, the nominal width of valve chamber 1 thus matches the diameter of flow line 8, at the input and output of the face-to-face dimension, that is, it matches the distance between the two parallel end faces 11, the dimensions defined by the standards for valves and fittings of the sandwich design, specifically for butterfly valves or ball valves. As an example, reference is made to European Standard EN 558-1, Base Series 16, in which a face-to-face dimension of 64 mm is indicated for a nominal diameter of DN=100 mm. Given the same nominal diameter, the face-to-face dimension in the cited standard in Base Series 20 is 52 mm. As is evident here, the face-to-face diameter is in any case significantly shorter than the nominal diameter.

We claim:

1. Globe valve with a valve chamber 1 which has a flow line that may be shut off by a plug actuatable by an axially adjustable valve spindle, wherein the plug in the shutoff position rests forming a seal against a valve seat oriented obliquely to the direction of flow, characterized in that the nominal width and face-to-face dimension of the valve chamber match the dimensions defined by the standards for valves and fittings of the sandwich design.

2. Globe valve according to claim 1, characterized in that the nominal width and face-to-face dimension of the valve chamber match the dimensions defined by the standard for butterfly valves, slide valves, or ball valves of the sandwich design.

3. Globe valve according to claim 1, in which the valve chamber has a flange, characterized in that the flange is provided with threaded holes into which screws may be inserted through the pipeline flanges.

4. Globe valve according to claim 1, in which the valve chamber has a flange through which screws may be inserted by which pipeline flanges are interconnectable, characterized in that the flange is centered relative to the face-to-face dimension.

5. Globe valve according to claim 1, characterized in that the seating face of the valve seat is circumferentially inclined so that the intersections of the respective diametrically opposing generating lines comprise a surface.

6. Valve according to claim 1, characterized in that the valve spindle is eccentrically tilted relative to the plug depending on the oblique orientation of the valve seat.
